(19) United States
(12) Patent Application Publication
(10) Pub. No.: US 2012/0066577 A1
(43) Pub. Date: Mar. 15, 2012

(54) Concurrent Editing of Online Drawings

(75) Inventors: Shailesh Saini, Kirkland, WA (US); Brian Albrecht, Kirkland, WA (US)

(73) Assignee: MICROSOFT CORPORATION, Redmond, WA (US)

(21) Appl. No.: 12/878,842

(22) Filed: Sep. 9, 2010

(51) Int. Cl. G06F 3/01; G06F 15/16; G06F 17/00

(52) U.S. Cl. 715/211; 715/751; 709/203

(57) ABSTRACT

A webpage contains a canvas. The canvas contains a drawing that is editable within the webpage by a user of a client device and by other users who use other client devices to open webpages that include the canvas. While the webpage is open on the client device, the drawing is dynamically updated to reflect edits made to the drawing by the user and by the other users at approximately times that the user and the other users make the edits to the drawing. The drawing is stored on a server system such that when the user closes the webpage, the other users can continue to edit the drawing. When the user reopens the webpage, the canvas contains the drawing as edited by the other users.

### BACKGROUND

Social networking services provide websites that help people to communicate with other people in their social networks. People tend to communicate in social networking services primarily using text. However, there are times when it would be more convenient or enjoyable to communicate using drawings. Unfortunately, it is not convenient to communicate using drawings in social networking services. For example, some social networking services allow people to upload and send drawings to other people. However, these drawings are not editable by the recipients of the drawings. Rather, these drawings are typically static images, such as JPG or GIF files. In another example, some social networking services allow users to collaborate on a drawing during a chat or instant messaging session, but such drawings do not persist beyond the communication session.

### SUMMARY

A webpage contains a canvas. The canvas contains a drawing that is editable within the webpage by a user of a client device and by other users who use other client devices to open webpages that include the canvas. While the webpage is open on the client device, the drawing is dynamically updated to reflect edits made to the drawing by the user and by the other users at approximately times that the user and the other users make the edits to the drawing. The drawing is stored on a server system such that when the user closes the webpage, the other users can continue to edit the drawing. When the user reopens the webpage, the canvas contains the drawing as edited by the other users.

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example system.

FIG. 2 is a block diagram illustrating example details of a client device.

FIG. 3 illustrates an example browser window.

FIG. 4 is a block diagram illustrating example details of a server system.

FIG. 5 is a flowchart illustrating a first part of an example operation performed by the client device.

FIG. 6 is a flowchart illustrating a second part of the example operation performed the client device.

FIG. 7 is a flowchart illustrating a third part of the example operation performed by the client device.

FIG. 8 is a flowchart illustrating a first part of an example operation performed by the server system.

FIG. 9 is a flowchart illustrating a second part of an example operation performed by the server system.

FIG. 10 is an example screen illustration that shows an example browser window.

FIG. 11 is an example screen illustration that shows the webpage when a canvas is displayed in a status update area.

FIG. 12 is an example screen illustration that shows the example webpage after the canvas has been added to the webpage.

FIG. 13 is a block diagram illustrating an example computing device.

### DETAILED DESCRIPTION

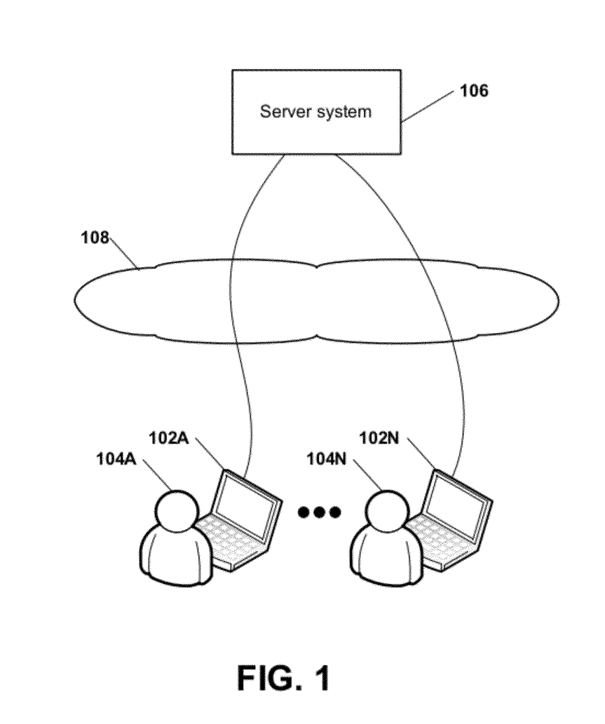

FIG. 1 is a block diagram illustrating an example system 100. The system 100 includes client devices 102A through 102N (collectively, “client devices 102”). The client devices 102 are computing devices, such as personal computers and handheld devices. Users 104A through 104N (collectively, “users 104”) are people who use the client devices 102.

The system 100 also includes a server system 106. The server system 106 is a system comprising one or more computing devices. The client devices 102 are able to communicate with the server system 106 via a network 108. The network 108 is a communications network, such as the Internet or a local area network. The network 108 can include wired and/or wireless telecommunications links.

The server system 106 hosts a social networking service. The social networking service includes a social networking website that focuses on building and reflecting social networks among people. The client devices 102 communicate with the server system 106 via the network 108 to enable the users 104 to access the social networking service.

As described in this document, the users 104 use the client devices 102 to open a webpage in the social networking website. The webpage contains a canvas. The canvas comprises an area within the webpage in which the users 104 can collaborate to create a drawing. The drawing can include various elements, such as straight lines, curved lines, rectangles, circles, text, arrows, images, and so on. Furthermore, in some embodiments, the drawing can include picture elements. Picture elements are bitmap images inside the drawing. The canvas can also include onscreen tools that enable the users 104 to add elements to the drawing. For example, the canvas can include onscreen tools that enable the user 104 to add circles, rectangles, lines, text, and other types of elements to the drawing.

While the webpage is open on the client devices 102, the client devices 102 dynamically update the drawing to reflect changes made to the drawing by the users 104 at approximately the same time that the users 104 make the changes to the drawing. In this way, if the webpage is open in two or more of the client devices 102, the users of these client devices can see the changes to the drawing as they are being made. For example, if the webpage is open in the client device 102A and the client device 102B and the user 104B makes a change to the drawing, the user 104A can see the change at approximately the same time that the user 104B is making the change.

Subsequently, some or all of the users 104 can close the webpage. When the users 104 close the webpage, the contents of the drawing are not lost. Rather, the state of the drawing is preserved such that when the users 104 reopen the webpage, the users 104 can continue to edit the drawing without starting over.

Individual ones of the users 104 can edit the drawing without the webpage being open on the client devices 102 of other ones of the users 104. For example, a first one of the users 104 can be the only user who has the webpage open. In this example, the first user can edit the drawing and then close the webpage. When the first user closes the webpage, the contents (i.e., the elements in the drawing and the attributes of those elements) of the drawing are in a first state. In this example, a second one of the users 104 opens the webpage after the first user has closed the webpage. When the second user opens the webpage, the drawing reflects the changes made by the first user. In this example, the second user can then make additional changes to the drawing. The first user then reopens the webpage. When the first user reopens the webpage, the contents of the drawing are in a second state. The second state results from changes to the drawing by the second user while the webpage was closed on the client device of the first user.

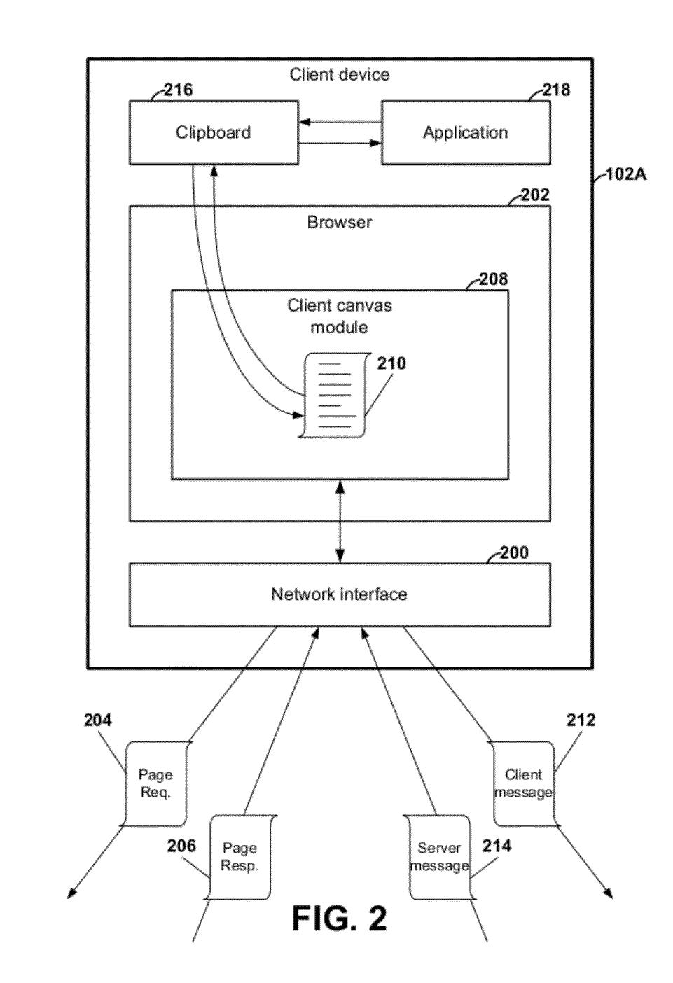

FIG. 2 is a block diagram illustrating example details of the client device 102A. It should be appreciated that other ones of the client devices 102 can have details similar to those illustrated for the client device 102A in the example of FIG. 2. In some embodiments, the following description of the client device 102A and the user 104A is equally applicable with respect to the other ones of the client devices 102 and the users 104.

The client device 102A is a computing device. In various embodiments, the client device 102A can be various types of computing devices. For example, the client device 102A can be a personal computer, a laptop computer, a handheld computer, a netbook computer, a smartphone, a tablet computer, an in-car computer, a television set-top box, a video game console, a handheld video game device, or another type of computing device.

As illustrated in the example of FIG. 2, the client device 102A comprises a network interface 200. The network interface 200 enables the client device 102A to communicate with other computing devices over the network 108. The client device 102A also provides a browser 202. The browser 202 is a software application that enables the user 104A to open documents, such as webpages, via a communications network. In some embodiments, the client device 102A provides the browser 202 when a processing unit of the client device 102A executes certain computer-executable instructions stored on one or more computer storage media. Example types of browsers include the MICROSOFT® INTERNET EXPLORER® web browser, the Mozilla Firefox web browser, the Google Chrome web browser, the Apple Safari web browser, the RIM BlackBerry web browser, the Opera web browser, and so on.

The browser 202 receives input from the user 104A to open a website hosted by the server system 106. In response, the browser 202 causes the network interface 200 to send a webpage request 204 to the server system 106. The webpage request 204 is a request by the browser 202 for data that represents the requested webpage. In various embodiments, the webpage request 204 is formatted in various ways. For example, in some embodiments, the webpage request 204 is formatted as a Hypertext Transfer Protocol (HTTP) request. Subsequently, the browser 202 receives a webpage response 206 through the network interface 200. The webpage response 206 contains data that represents the requested webpage.

When the browser 202 receives the webpage response 206, the browser 202 processes the data representing the webpage to prepare the webpage for display. When the browser 202 processes the data representing the webpage, the browser 202 determines whether the webpage includes a canvas. If the browser 202 determines that the webpage includes a canvas, the browser 202 starts a client canvas module 208. The client canvas module 208 manages the canvas.

In order to manage the canvas, the client canvas module 208 maintains a client model 210. The client model 210 comprises data that represents a drawing within the canvas. In various embodiments, the client model 210 represents the drawing in various ways. For example, the client model 210 can comprise a hierarchy of XML elements that represents the drawing. In this example, the hierarchy of XML elements can conform to the DrawingML format specified in the Open Office XML (ECMA-376) standard or another format. In this example, the hierarchy of XML elements can include an XML element that represents the drawing as a whole. Within this XML element are other XML elements that represent individual elements within the drawing. The individual elements within the drawing can include lines, rectangles, text, circles, and so on. Each of the XML elements include attributes that specify attributes of the elements.

After the browser 202 opens the webpage, the client canvas module 208 receives input from the user 104A to edit the drawing. For example, the client canvas module 208 can receive input to add elements to the drawing, modify attributes of existing elements in the drawing, delete existing elements from the drawing, and so on. In response to such input, the client canvas module 208 updates the client model 210 to reflect changes indicated by the input. Furthermore, the client canvas module 208 updates the canvas within the webpage such that the drawing reflects the changes indicated by the input.

In addition, when the client canvas module 208 receives input from the user 104A to make changes to the drawing, the client canvas module 208 causes the network interface 200 to send client messages 212 to the server system 106. The client messages 212 specify the changes to the drawing. For example, if the input was to delete an element from the drawing, a client message indicates that the element has been deleted from the drawing. In this way, the server system 106 is kept abreast of the status of the drawing at the client device 102A.

In various embodiments, the client messages 212 are formatted in various ways. For example, in embodiments where the client model 210 comprises an XML element hierarchy that represents the drawing, the client messages 212 specify the changes to the drawing by specifying changes to one or more XML elements in the client model 210.

The client canvas module 208 also receives server messages 214 from the server system 106. The server messages 214 specify changes made to the drawing by other users. The client canvas module 208 updates the client model 210 to reflect the changes specified in the server messages 214. In this way, the client canvas module 208 is kept abreast of the status of the drawing at the server system 106. In addition, the client canvas module 208 dynamically updates the drawing displayed to the user 104A to reflect the changes specified in the server messages 214.

In various embodiments, the server messages 214 are formatted in various ways. For example, in embodiments where the client model 210 comprises an XML element hierarchy that represents the drawing, the server messages 214 specify the changes to the drawing by specifying changes to one or more XML elements in the client model 210.

Because multiple users can be editing the drawing concurrently, conflicting changes can occur. For example, one of the users 104 (e.g., user 104A) may try to delete a particular element while another one of the users 104 (e.g., the user 104B) is trying to modify one or more attributes of the particular element. Hence, there is a conflict between the change made by the user 104A and the change made by the user 104B. To avoid such conflicts, elements in the drawing cannot typically be modified or deleted unless the users 104 first select the elements. Whenever the users 104 select elements in the drawing, the client devices 102 send lock requests to the server system 106. The lock requests specify the selected elements. When the server system 106 receives a lock request specifying a particular element in the drawing, the server system 106 locks the particular element such that no other user can modify or delete the element while the particular element is selected. In this way, the server system 106 prevents a first user from modifying or deleting a given element in the drawing when a second user has selected the given element, and vice versa.

As illustrated in the example of FIG. 2, the client device 102A also provides a clipboard 216 and an application 218. In some embodiments, the client device 102A provides the clipboard 216 and the application 218 by executing computer-executable instructions. The application 218 enables the user 104A to edit a document. In various embodiments, the application 218 can be a variety of different types of applications. For example, the application 218 can be a word processor application (such as Microsoft® Word), a slideshow application (such as Microsoft® PowerPoint®), a note taking application (such as Microsoft® OneNote®), an email application (such as Microsoft® Outlook®), a diagram editing application (such as Microsoft® Visio®), or another type of application that enables the user 104A to edit a document.

The user 104A can provide copy input to the browser 202 while the webpage is open in the browser 202. In various embodiments, the user 104A can provide the copy input to the browser 202 in various ways. For example, the user 104A can select the drawing and then press a key combination (e.g., control-c) on a keyboard. In another example, the browser 202 displays a pop-up menu when the user 104A right-clicks on the canvas. In this example, the user 104A provides the copy input to the browser 202 by selecting a copy command from the pop-up menu.

In response to receiving the copy input, the browser 202 copies the client model 210 to the clipboard 216. The user 104A can then paste the drawing into a document that is open in the application 218. When the user 104A pastes the drawing into the document, the application 218 incorporates the client model 210 into a document model. The document model comprises data that represents the document. For example, the client model 210 and the document model can comprise hierarchies of XML elements. In this example, the application 218 incorporates the hierarchy of XML elements in the client model 210 into the hierarchy of XML elements in the document model. After the user 104A pastes the drawing into the document, the user 104A can continue to edit the drawing while the drawing is in the document.

In some embodiments, the user 104A can provide a copy input to the application 218. The copy input instructs the application 218 to copy a drawing in a document that is open in the application 218. In response, the application 218 copies a model of the drawing to the clipboard 216. For example, where the document model comprises a hierarchy of XML elements, the application 218 copies the XML elements that represent the drawing into the clipboard 216. The user 104A can then instruct the browser 202 to paste the drawing from the clipboard 216 into a canvas in a webpage open in the browser 202. For example, where a hierarchy of XML elements represents the drawing, the browser 202 can provide this hierarchy of XML elements to the client canvas module 208 as the client model for the drawing.

In some embodiments, the user 104A is able to copy and paste some elements in the drawing. To do this, the user 104A selects one or more individual elements within the drawing displayed in the webpage. The user 104A then provides a copy input to the browser 202. In response, the browser 202 generates a new model in the clipboard 216. The new model represents the selected elements of the drawing, but not unselected elements of the drawing. The user 104A can later provide paste input to the application 218. In response, the application 218 incorporates the new model into a document model of a document open in the application 218. In this way, the document contains the drawing represented by the new model (i.e., the selected elements). A similar process can occur to copy and paste individual elements in a drawing in a document open in the application 218 into a drawing in a webpage open in the browser 202.

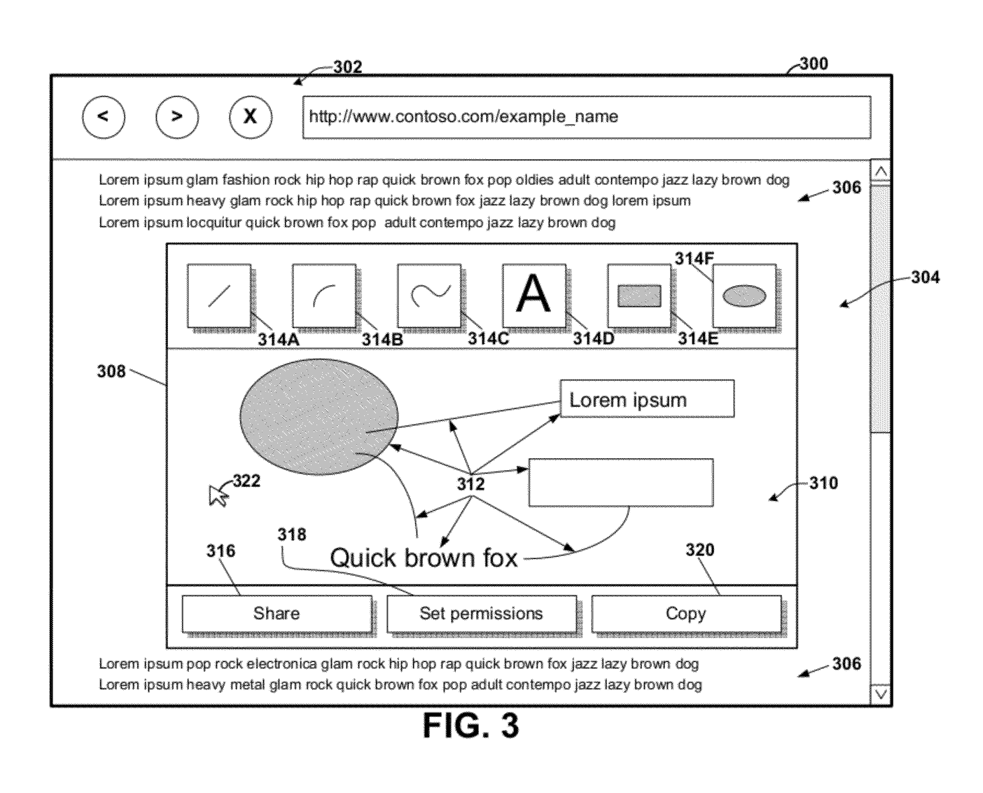

FIG. 3 illustrates an example browser window 300. The browser window 300 is a window displayed by the browser 202. The browser window 300 comprises navigation controls 302. The navigation controls 302 enable the user 104A to control navigation.

The browser window 300 also comprises a webpage 304. In the example of FIG. 3, the webpage 304 comprises text blocks 306. In addition to the text blocks 306, the webpage includes a canvas 308. The canvas 308 includes a drawing 310. The drawing 310 includes a set of elements 312.

The canvas 308 also includes drawing controls 314A through 314F (collectively, “drawing controls 314”). To add an element to the drawing 310, the user 104A selects one of the drawing controls 314. The user 104A then uses an input device to make a gesture that suggests a position and/or shape for the element. For example, to draw a line, the user 104A selects the drawing control 314A. In this example, the user 104A then depresses a button when a cursor 322 is at a point within the drawing 310 where the line should start and releases the button when the cursor 322 is at a point within the drawing 310 where the line should end. In another example, to add text to the drawing 310, the user 104A selects the drawing control 314D. In this example, the user 104A depresses a button when the cursor 322 is at a point within the drawing 310 where a corner of a textbox is to appear and releases the button when the cursor 322 is at a point within the drawing 310 where a diagonally opposite corner of the textbox is to appear. In this example, the user 104A can the use a keyboard or other input device to enter text into the textbox.

In various embodiments, the user 104A selects elements in the drawing 310 in various ways. For example, the user 104A can select an element in the drawing 310 by positioning the cursor 322 over the element and depressing a button. In another example, the user 104A can select an element in the drawing 310 by repeatedly pressing a particular keyboard button (e.g., “tab”). In this example, a different element in the drawing 310 is selected each time the user 104A presses the particular keyboard button. In another example, the browser window 300 is displayed on a touch-sensitive display. In this example, the user 104A can select an element in the drawing 310 by touching the element on the touch-sensitive display.

While an element is in a selected state, the user 104A can delete the element. In various embodiments, the user 104A performs various actions to delete the element. For example, the user 104A can delete the element by pressing a keyboard button (e.g., “delete” or “backspace”). In another example, the user 104A can delete the element by selecting an on-screen control (not shown).

While an element is in a selected state, the user 104A can modify one or more attributes of the element. The user 104A can modify different attributes of the element by performing different actions. For example, the user 104A can modify a position of the element by using the cursor 322 to drag the element to the desired position. In another example, the user 104A can modify a line color of the element by opening a color selection pane within the canvas 308 and selecting a desired color.

In some embodiments, the webpage 304 is part of a social networking website. For example, the webpage 304 can be a social networking profile page for the user 104A. A social networking profile page is a webpage that contains personal information about a user. The user's social networking profile page can act as a digital representation of the user's identity. In another example, the webpage 304 can be a webpage in the social networking website for a group of users. In yet another example, the webpage 304 can be a webpage in the social networking website linked to a group webpage or a user's profile page.

The canvas 308 also includes a share control 316. When the user 104A selects the share control 316, the browser 202 displays a contact list. The contact list is a list of people who have been designated by the user 104A as having direct social connections with the user 104A. The user 104A selects people from the contact list. The server system 106 invites the selected people to view and/or edit the drawing 310. For example, the server system 106 can send email messages or text messages to the selected people to invite the selected people to view and/or edit the drawing 310.

In the example of FIG. 3, the canvas 308 also includes a permissions control 318. When the user 104A selects the permissions control 318, the browser 202 displays a permission interface. The permission interface enables the user 104A to select which other people can view and/or edit the drawing 310. In various embodiments, the permission interface can include various information and can be formatted in various ways. For example, the server system 106 can send a list of the social networking contacts of the user 104A to the client device 102A. The social networking contacts of the user 104A are people who have been designated by the user 104A having direct social connections with the user 104A. In this example, the user 104A can use checkboxes or other types of controls to specify which ones of these people are authorized to view and/or edit the drawing 310. In another example, the permission interface can list people who are workplace colleagues of the user 104A. After the user 104A selects one or more people to view and/or edit the drawing, the browser 202 sends a permissions message to the server system 106. The permissions message indicates which users are authorized to view and/or edit the drawing.

In addition, the canvas 308 includes a copy control 320. When the user 104A selects the copy control 320, the browser 202 copies the client model 210 for the drawing 310 (or a model representing selected elements in the drawing 310) to the clipboard 216.

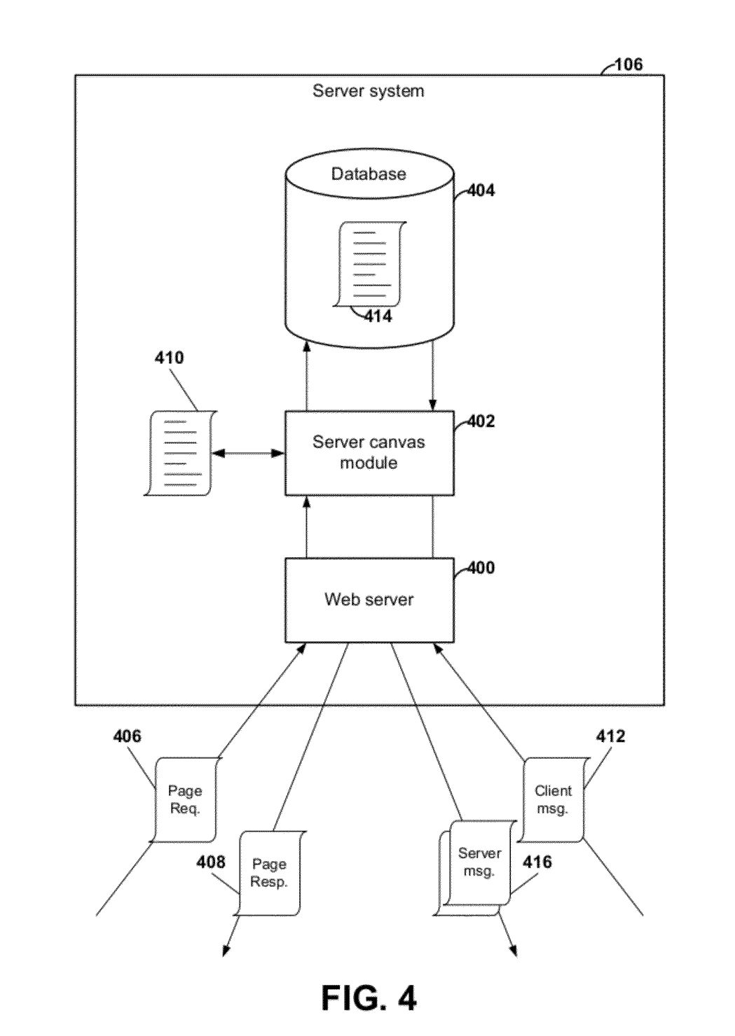

FIG. 4 is a block diagram illustrating example details of the server system 106. As mentioned above, the server system 106 comprises one or more computing devices. In various embodiments, the server system 106 can comprise various types of computing devices. For example, the server system 106 can comprise standalone server devices, blade server devices, personal computers, routers, switches, bridges, hubs, firewall devices, load balancers, storage devices, and other types of computing devices.

As illustrated in the example of FIG. 4, the server system 106 provides a web server 400 and a server canvas module 402. In some embodiments, the server system 106 provides the web server 400 and the server canvas module 402 when one or more computing devices in the server system 106 execute computer-executable instructions. The server system 106 also stores a database 404. In various embodiments, one or multiple computing devices within the server system 106 store the database 404.

The web server 400 receives webpage requests 406 from the client devices 102. The webpage requests 406 are requests to open webpages hosted by the server system 106. In various embodiments, the webpage requests 406 are formatted in various ways. For example, in some embodiments, the webpage requests 406 are formatted as Hypertext Transfer Protocol (HTTP) requests. The web server 400 sends webpage responses 408 as responses to the webpage requests 406. The webpage responses 408 contain data that represents the webpage.

Furthermore, when the web server 400 receives a webpage request from the client device 102A and the requested webpage includes a canvas, the server canvas module 402 adds the client device 102A to a subscription list 410. The subscription list 410 lists ones of the client devices 102 that have opened a webpage that includes the canvas.

Subsequently, the web server 400 receives client messages 412 from the client devices 102. The client messages 412 specify changes made by users of the client devices 102 to a drawing in the canvas. For example, the client messages 412 can specify the addition of an element to the drawing, a selection of an element in the drawing, and so on. When the web server 400 receives the client messages 412, the server canvas module 402 updates a server model 414 in the database 404. The server model 414 contains data that represents the drawing. The server canvas module 402 updates the server model 414 to reflect the changes to the drawing indicated by the client messages 412. For example, the server model 414 can comprise an XML element hierarchy that represents the drawing. In this example, one of the client messages 412 can indicate that the user 104A has deleted a given element from the drawing. In this example, the server canvas module 402 updates the XML element hierarchy in the server model 414 to remove XML elements that represent the given element.

When the server canvas module 402 updates the server model 414 to reflect a change to the drawing, the server canvas module 402 sends server messages 416 to each of the client devices listed in the subscription list 410. The server messages 416 specify changes to the drawing. In various embodiments, the server messages 416 can specify changes to the state of the drawing in various ways. For example, if the server canvas module 402 deletes an XML element that represents a given element in the drawing, the server messages 416 specify that the XML element has been deleted from the server model 414. By processing the server messages 416, the client devices 102 can keep abreast of changes to the drawing made by other ones of the client devices 102.

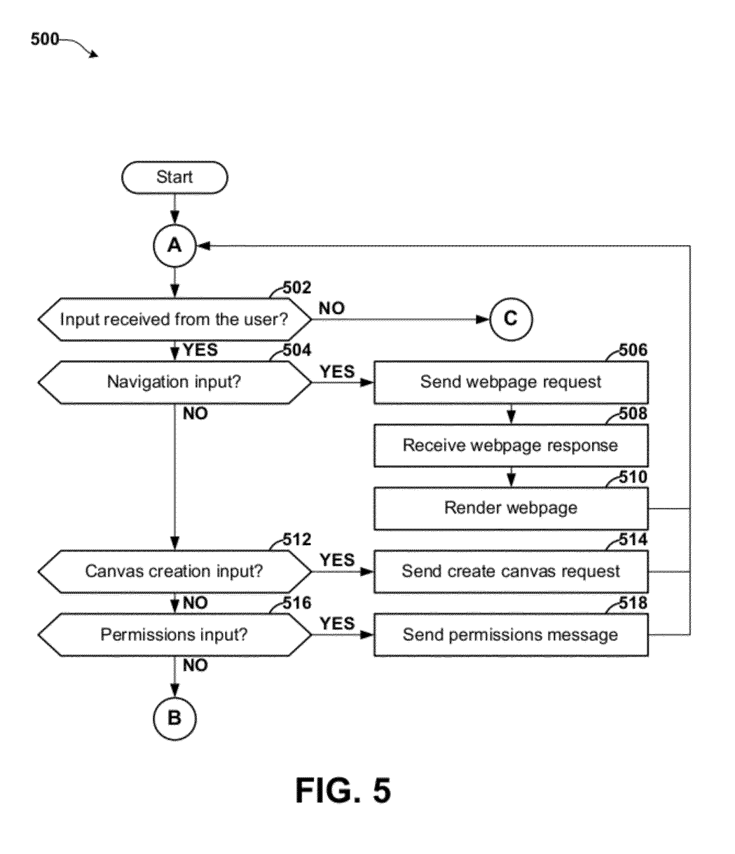

FIG. 5 is flowchart illustrating an example operation 500 performed by the client device 102A. Although this document describes the operation 500 as being performed by the client device 102A, any of the client devices 102 can perform the operation 500.

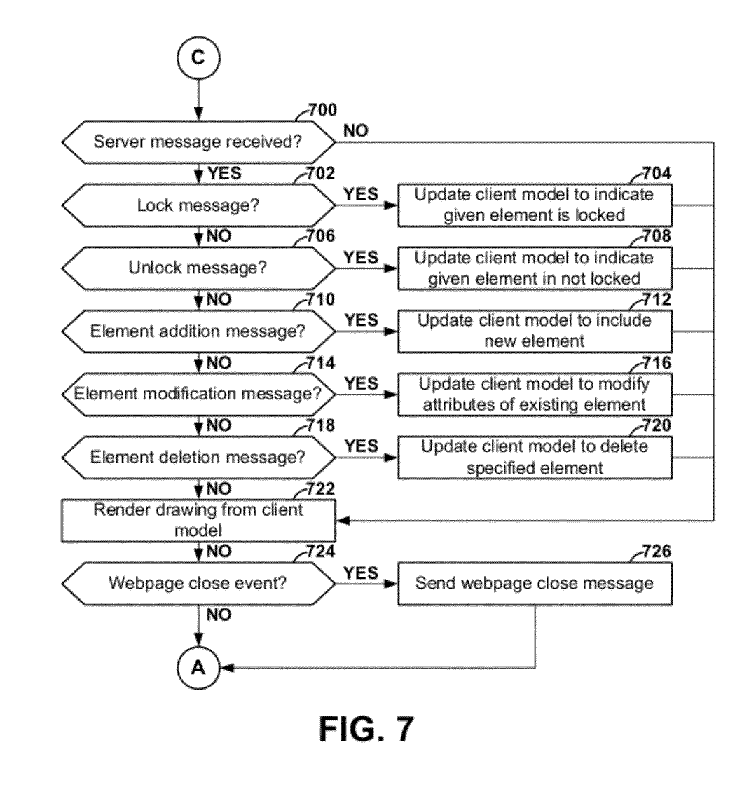

As illustrated in the example of FIG. 5, the operation 500 begins when the browser 202 determines whether input has been received from the user 104A (502). If input has not received from the user (“NO” of 502), the operation 500 proceeds to the circle marked “C” in FIG. 7. If input has been received from the user 104A (“YES” of 502), the browser 202 determines whether the input is navigation input (504). Navigation input is input that instructs the browser 202 to open a webpage. In various embodiments, the browser 202 can receive various types of navigation input. For example, the browser 202 can receive navigation input when the user 104A selects a back button, a forward button, a reload button, enters a new address in a navigation bar, clicks on a hyperlink, or provides another type of input that instructs the browser 202 to open a webpage. If the input is navigation input (“YES” of 504), the browser 202 sends a webpage request to the server system 106 (506). The webpage request is a request to open a webpage. Subsequently, the browser 202 receives a webpage response from the server system 106 (508). The webpage response includes data that represents the webpage. The browser 202 then renders the webpage such that the webpage is displayed to the user 104A (510). After rendering the webpage, the operation 500 restarts.

On the other hand, if the input is not a navigation input (“NO” of 504), the client canvas module 208 determines whether the input is a canvas creation input (512). The canvas creation input indicates that the user 104A wants to include a canvas in the webpage. In various embodiments, the user 104A can provide the canvas creation input to the browser 202 in various ways. For example, in some embodiments, the webpage can include a control that, when selected, provides the canvas creation input to the browser 202. If the input is a canvas creation input (“YES” of 512), the client canvas module 208 sends a client message comprising a canvas creation request to the server system 106 (514). The canvas creation request instructs the server system 106 to create a new canvas within the webpage. In some embodiments, the client canvas module 208 can send the canvas creation request to the server system 106 automatically without input from the user. For instance, the client canvas module 208 can send the canvas creation request to the server system 106 when the webpage loads. After sending the create canvas request to the server system 106, the operation 500 restarts.

If the input is not a canvas creation input (“NO” of 512), the client canvas module 208 determines whether the input is a permission input (516). A permission input is an input from the user 104A to set permissions for the canvas. The permissions for the canvas govern which other users are authorized to view and/or edit the canvas. In various embodiments, the user 104A provides the permission input in various ways. For example, the client device 102A can display a list of users of the social networking service to the user 104A. The user 104A can then provide the permission input by selecting users from among the users of the social networking service. In this example, the users that are not selected are not authorized to edit the drawing.

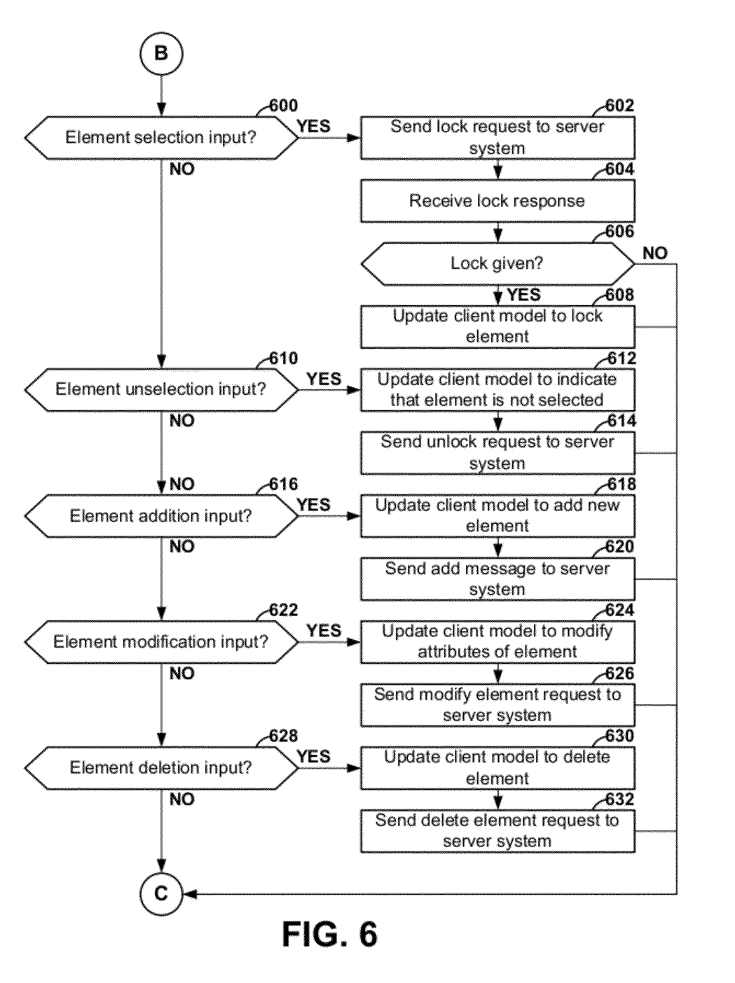

If the input is a permission input (“YES” of 516), the client canvas module 208 sends to the server system 106 a client message that comprises a permissions message (518). The permissions message instructs the server system 106 to set or update permissions for the canvas. After sending the client message, the operation 500 restarts. If the input is not a permission input (“NO” of 516), the client canvas module 208 performs the portion of the operation 500 illustrated in FIG. 6 starting at the circle marked “B.”

FIG. 6 is a flowchart illustrating a second part of the operation 500. Following the circle marked “B,” the client canvas module 208 determines whether the input is an element selection input (600). An element selection input is an input from the user 104A to select an existing element in the drawing. If the client canvas module 208 determines that the input is an element selection input (“YES” of 600), the client canvas module 208 sends a client message comprising a lock request to the server system 106 (602). Subsequently, the client canvas module 208 receives a server message comprising a lock response from the server system 106 (604). The lock response message indicates whether the server system 106 has given the client canvas module 208 a lock on the existing element. Hence, when the client canvas module 208 receives the lock response message from the server system 106, the client canvas module 208 uses the lock response message to determine whether the server system 106 has given the client canvas module 208 a lock on the existing element (606). If the server system 106 has given the client canvas module 208 a lock on the existing element (“YES” of 606), the client canvas module 208 updates the client model 210 to indicate that the client canvas module 208 has a lock on the existing element (608). After the client canvas module 208 updates the client model in step 608 or after the client canvas module 208 determines that the server system 106 did not give the client canvas module 208 a lock on the existing element (“NO” of 606), the operation 500 continues at the circle marked “C” in FIG. 7.

If the input is not an element selection input (“NO” of 600), the client canvas module 208 determines whether the input is an element unselection input (610). An element unselection input is an input to unselect a given element in the drawing. In various embodiments, the user 104A can provide an element unselection input in various ways. For example, the user 104A can provide an element unselection input by selecting a portion of the canvas that does not contain an element or by selecting another element in the drawing. If the input is an element unselection input (“YES” of 610), the client canvas module 208 updates the client model 210 to indicate that the given element specified by the element unselection input is no longer selected (612). In addition, the client canvas module 208 sends a client message comprising an unlock request to the server system 106 (614). The unlock request indicates to the server system 106 that the client canvas module 208 no longer needs a lock on the given element. After the client canvas module 208 sends the client message in step 614, the operation 500 continues at the circle marked “C” in FIG. 7.

If the input is not an element unselection input (“NO” of 610), the client canvas module 208 determines whether the input is an element addition input (616). The element addition input is input to add a new element to the drawing. If the input is an element addition input (“YES” of 616), the client canvas module 208 updates the client model 210 to include the new element specified by the element addition input (618). The client canvas module 208 then sends a client message comprising an add element request to the server system 106 (620). The add element request specifies the new element. After the client canvas module 208 sends the client message in step 620, the operation 500 continues at the circle marked “C” in FIG. 7.

If the input is not an element addition input (“NO” of 616), the client canvas module 208 determines whether the input is an element modification input (622). An element modification input is an input to modify one or more attributes of a given element that already exists in the drawing. If the input is an element modification input (“YES” of 622), the client canvas module 208 updates the client model 210 to modify the one or more attributes of the given element (624). The client canvas module 208 then sends a client message that comprises a modify element request to the server system 106 (626). The modify element request indicates the changes to the attributes of the given element. After the client canvas module 208 sends the client message in step 626, the operation 500 continues at the circle marked “C” in FIG. 7.

If the input is not an element modification input (“NO” of 622), the client canvas module 208 determines whether the input is an element deletion input (628). An element deletion input is an input to delete one or more elements in the drawing. If the input is an element deletion input (“YES” of 628), the client canvas module 208 updates the client model 210 to delete the one or more element (630). The client canvas module 208 then sends a client message comprising a delete element request to the server system 106 (632). The delete element request indicates that the one or more elements have been deleted from the drawing. After the client canvas module 208 sends the client message in step 632, the operation 500 continues at the circle marked “C” in FIG. 7.

FIG. 7 is a flowchart illustrating a third part of the operation 500. As illustrated in FIG. 7, the operation 500 continues at the circle marked “C”. Initially, the client canvas module 208 determines whether the client device 102A has received a server message (700). A server message is a message sent by the server system 106 to the client device 102A. If the client canvas module 208 determines that the client device 102A has received a server message (“YES” of 700), the client canvas module 208 determines whether the server message comprises a lock message (702). A lock message indicates that the server system 106 has locked a given element in the server model 414. If the server message comprises a lock message (“YES” of 702), the client canvas module 208 updates the client model 210 to indicate that the given element is locked (704).

If the server message does not comprise a lock message (“NO” of 702), the client canvas module 208 determines whether the server message comprises an unlock message (706). A unlock message indicates that the server system 106 has unlocked a given element. If the server message comprises an unlock message (“YES” of 706), the client canvas module 208 updates the client model 210 to indicate that the given element is unlocked (708).

If the server message does not comprise an unlock message (“NO” of 706), the client canvas module 208 determines whether the server message comprises an element addition message (710). An element addition message indicates that the server system 106 has added a new element to the drawing. If the server message comprises an element addition message (“YES” of 710), the client canvas module 208 updates the client model 210 to include the new element (712).

If the server message does not comprise an element addition message (“NO” of 710), the client canvas module 208 determines whether the server message comprises an element modification message (714). An element modification message indicates that one or more attributes of an element in the drawing have been modified. For example, the element modification message can indicate that the line color, position, size, line width, fill color, font, or other attributes of an element that already exists in the drawing have been modified. If the server message comprises an element modification message (“YES” of 714), the client canvas module 208 updates the client model 210 to modify the attributes of the existing element as specified by the element modification message (716).

If the server message does not comprise an element modification message (“NO” of 714), the client canvas module 208 determines whether the server message comprises an element deletion message (718). An element deletion message indicates that an element has been deleted from the drawing. If the server message comprises an element deletion message (“YES” of 718), the client canvas module 208 updates the client model 210 to delete the element specified by the element deletion message (720).

If the client canvas module 208 determines that no server message was received (“NO” of 700) or after performing one of steps 704, 708, 712, 716, or 720, the client canvas module 208 renders the drawing from the client model 210 (722). In this way, the drawing displayed to the user 104A reflects the client model 210.

After rendering the drawing from the client model 210, the client canvas module 208 determines whether a webpage close event has occurred (724). A webpage close event occurs when the user 104A navigates away from the webpage in the browser 202, when the user 104A closes a browser window containing the webpage, or when the user 104A otherwise causes the webpage to no longer be open in a browser window. In response to determining that a webpage close event has occurred (“YES” of 724), the client canvas module 208 sends to the server system 106 a client message containing a webpage close indicator (726). The webpage close indicator indicates to the server system 106 that the webpage is no longer open on the client device 102A. After sending the client message to the server system 106 in step 726 or after determining that no webpage close event has occurred (“NO” of 724), the operation 500 restarts.

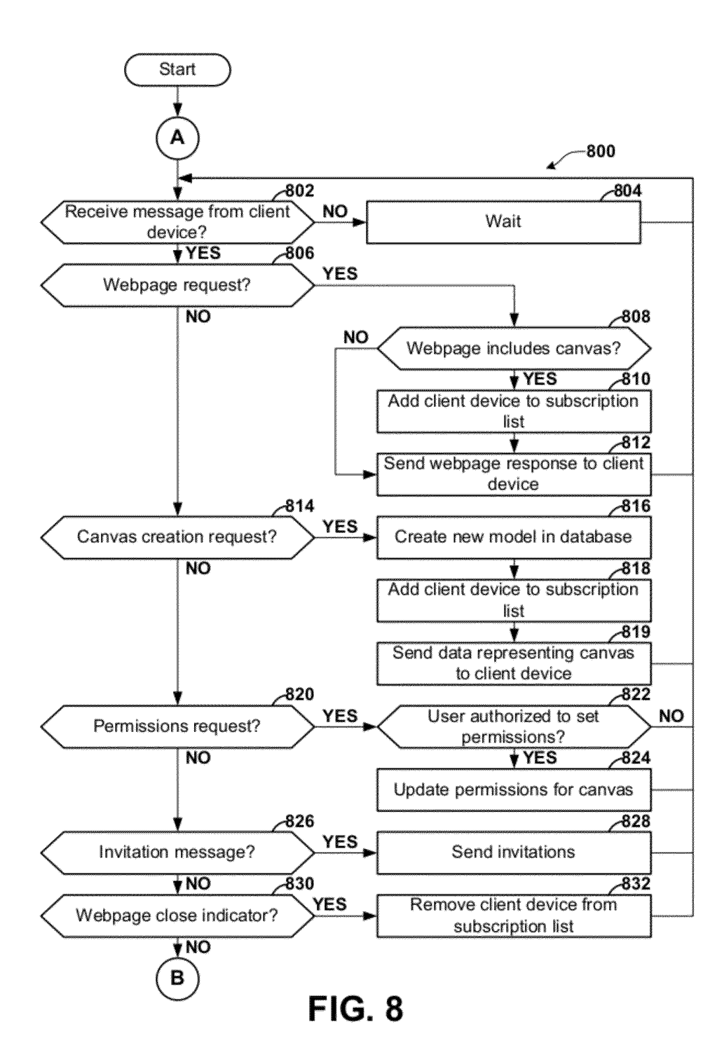

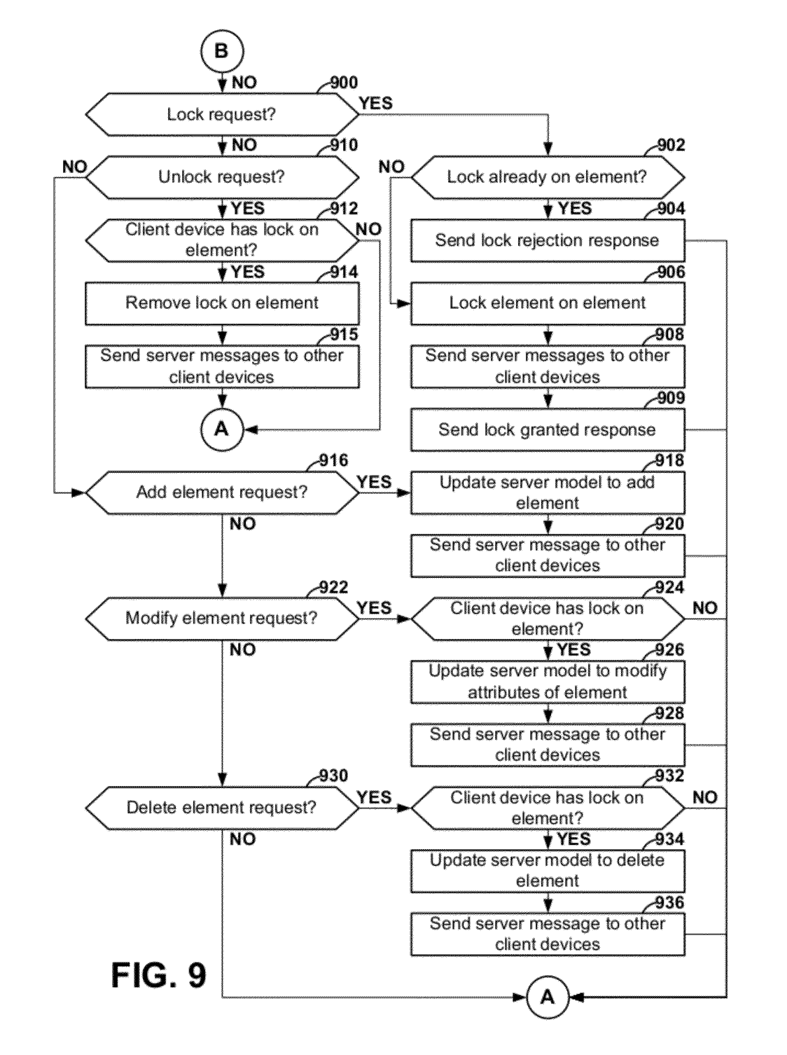

FIG. 8 is a flowchart illustrating a first part of an example operation 800 performed by the server system 106. As illustrated in the example of FIG. 8, the operation 800 begins when the web server 400 determines whether the server system 106 has received a message from one of the client devices 102 (802). For ease of explanation, the discussion of FIGS. 8 and 9 assumes that the server system 106 receives the message from the client device 102A. If the server system 106 has not received a message from any of the client devices 102 (“NO” of 802), the server canvas module 402 waits to receive a message from one of the client devices 102 (804).

On the other hand, if the server system 106 has received a message from the client device 102A (“YES” of 802), the server system 106 determines whether the message comprises a webpage request (806). The webpage request comprises a request to open a webpage. If the message comprises a webpage request (“YES” of 806), the web server 400 determines whether the webpage includes a canvas (808). If the webpage includes a canvas (“YES” of 808), the server canvas module 402 adds the client device 102A to the subscription list 410 (810). After the server canvas module 402 adds to client device 102A to the subscription list 410 or after determining that the webpage does not include a canvas (“NO” of 808), the web server 400 sends a webpage response to the client device 102A (812). The webpage response contains data that represents the webpage. After sending the webpage response to the client device 102A, the operation 800 restarts.

If the message does not comprise a webpage request (“NO” of 806), the server canvas module 402 determines whether the message is a client message that comprises a canvas creation request (814). A canvas creation request instructs the server canvas module 402 to create a new canvas within a webpage. If the client message comprises a canvas creation message (“YES” of 814), the server canvas module 402 creates a new model in the database 404 (816). The new model comprises data that represents a drawing in a new canvas. The server canvas module 402 then adds the client device 102A to the subscription list 410 (818). Next, the server canvas module 402 sends data representing the new canvas to the client device 102A (819). In various embodiments, the data representing the new canvas is formatted in various ways. For example, in some embodiments, the data representing the new canvas is formatted as a set of XML elements and sent to the client device 102A using AJAX technology. After sending the data representing the new canvas to the client device 102A, the operation 800 restarts.

If the client message does not comprise a canvas creation request (“NO” of 814), the server canvas module 402 determines whether the client message comprises a permissions request (820). A permissions request instructs the server canvas module 402 to set or update permissions for a canvas. The permissions for a canvas govern which users are authorized to view and/or edit the canvas. If the client message comprises a permissions message (“YES” of 820), the server canvas module 402 determines whether the user 104A is authorized to set the permissions for the canvas (822). If the user 104A is authorized to set the permissions for the canvas (“YES” of 822), the server canvas module 402 updates the permissions for the canvas as indicated by the permissions message (824). After updating the permissions for the canvas or after determining that the user is not authorized to set the permissions for the canvas (“NO” of 822), the operation 800 restarts.

If the client message does not comprise a permissions message (“NO” of 820), the server canvas module 402 determines whether the client message comprises an invitation message (826). An invitation message instructs the server canvas module 402 to send invitations to specified users. The invitations invite the specified users to view and/or edit a drawing. If the client message does not comprise an invitation message (“YES” of 826), the server canvas module 402 sends invitations to the specified users (828). After sending the invitations, the operation 800 restarts.

If the client message does not comprise an invitation message (“NO” of 826), the server canvas module 402 determines whether the client message comprises a webpage close indicator (830). If the client message comprises a webpage close indicator (“YES” of 830), the server canvas module 402 removes the client device 102A from the subscription list 410 (832). In this way, the client device 102A does not receive server messages regarding the canvas while the webpage containing the canvas is not open. After removing the client device 102A from the subscription list 410, the operation 800 restarts. On the other hand, if the client message does not comprise a webpage close indicator (“NO” of 830), the server canvas module 402 performs the portion of the operation 800 in FIG. 9.

FIG. 9 is a flowchart that illustrates a second part of the operation 800. If the client message does not comprise a webpage close indicator (“NO” of 830), the server canvas module 402 determines whether the client message comprises a lock request (900). A lock request instructs the server canvas module 402 to lock an element in the server model 414. If the client message comprises a lock request (“YES” of 900), the server canvas module 402 determines whether the server model 414 indicates that there is already a lock on the element specified by the lock request (902). If there is already a lock on the specified element, another user has already selected the element and has not unselected the element. Hence, if there is already a lock on the specified element (“YES” of 902), the server canvas module 402 sends a lock rejection response to the client device 102A (904). The lock rejection response indicates that the server system 106 did not give the lock to the client device 102A. On the other hand, if there is not already a lock on the specified element (“NO” of 902), the server canvas module 402 updates the server model 414 to indicate that the client device 102A has a lock on the specified element (906). The server canvas module 402 then sends server messages to the other client devices listed in the subscription list 410 (908). The server messages include lock messages. The lock messages indicate that the server system 106 has locked the specified element. The server canvas module 402 then sends a lock granted response to the client device 102A (909). The lock granted response indicates that the server system 106 gave a lock on the specified element to the client device 102A.

If the client message does not comprise a lock request (“NO” of 900), the server canvas module 402 determines whether the client message comprises an unlock request (910). The unlock request indicates that the client device 102A no longer needs a lock on a specified element. If the client message comprises an unlock request (“YES” of 910), the server canvas module 402 determines whether the client device 102A has a lock on the specified element (912). If the client device 102A has a lock on the specified element (“YES” of 912), the server canvas module 402 updates the server model 414 to remove the lock on the specified element (914). The server canvas module 402 then sends server messages to the other client devices listed in the subscription list 410 (915). Each of the server messages includes an unlock message. The unlock messages indicate that the server system 106 has unlocked the specified element. After updating the server model 414 or after determining that the client device 102A does not have a lock on the specified element (“NO” of 912), the operation 800 restarts.

If the client message does not comprise an unlock message (“NO” of 910), the server canvas module 402 determines whether the client message comprises an add element request (916). An add element request specifies an element to add to the server canvas module 402. If the client message comprises an add element request (“YES” of 916), the server canvas module 402 updates the server model 414 to add the specified element to the server model 414 (918). The server canvas module 402 then sends server messages to the other client devices listed in the subscription list 410 (920). Each of the server messages comprises an element addition message. The element addition messages indicate that the specified element has been added to the drawing. The operation 800 then restarts.

If the client message does not comprise an add element request (“NO” of 916), the server canvas module 402 determines whether the client message comprises a modify element request (922). A modify element request indicates changes to one or more attributes of an element in the drawing. If the client message comprises a modify element request (“YES” of 922), the server canvas module 402 determines whether the client device 102A has a lock on the specified element (924). If the client device 102A has a lock on the specified element (“YES” of 924), the server canvas module 402 updates the server model 414 to modify the attributes of the specified element as indicated by the modify element request (926). The server canvas module 402 then sends server messages to the other client devices listed in the subscription list 410 (928). Each of the server messages includes an element modification message. The element modification messages indicate that one or more attributes of the element have been modified. After sending the server messages in step 928 or after determining that the client device 102A does not have a lock on the specified element (“NO” of 924), the operation 800 restarts.

If the client message does not comprise a modify element request (“NO” of 922), the server canvas module 402 determines whether the client message comprises a delete element request (930). A delete element request indicates that one or more elements have been deleted from the drawing. If the client message comprises a delete element request (“YES” of 930), the server canvas module 402 determines whether the client device 102A has a lock on the specified element (932). If the client device 102A has a lock on the specified element (“YES” of 932), the server canvas module 402 updates the server model 414 to delete the specified element (934). The server canvas module 402 then sends server messages to the other client devices listed in the subscription list 410 (936). Each of the server messages includes an element deletion message. The element deletion messages indicate that the specified element has been deleted. After sending the server messages or after determining that the client device 102A does not have a lock on the specified element (“NO” of 932), the operation 800 restarts.

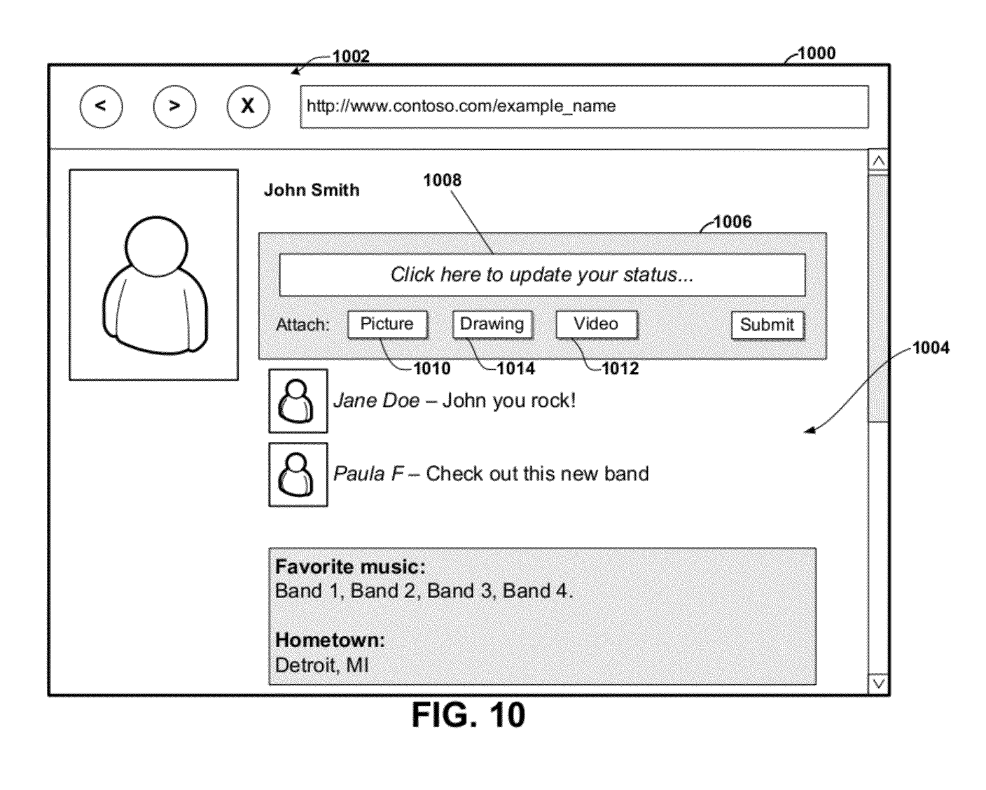

FIG. 10 is an example screen illustration that shows an example browser window 1000. The browser window 1000 is a window displayed by the browser 202. The browser window 1000 comprises navigation controls 1002. The navigation controls 1002 enable the user 104A to control navigation. The browser window 1000 also comprises a webpage 1004. In the example of FIG. 10, the webpage 1004 is a social networking profile page for a user named “John Smith.” The webpage 1004 contains personal information about the user, such as a picture of the user, the user's favorite music, and the user's hometown. The webpage 1004 also contains comments about the user from other users.

In addition, the webpage 1004 includes a status update area 1006. The status update area 1006 includes a text area 1008. The user can enter text into the text area 1008. Text entered into the text area 1008 is posted on the webpage 1004. In addition, text entered into the text area 1008 can be copied to pages of people who are socially connected to the user.

Furthermore, the status update area 1006 includes a picture control 1010. When the user selects the picture control 1010, the user can select an image file to attach to the text entered in the text area 1008. In addition, the status update area 1006 includes a video control 1012. When the user selects the video control 1012, the user selects a video file to attach to the text entered in the text area 1008.

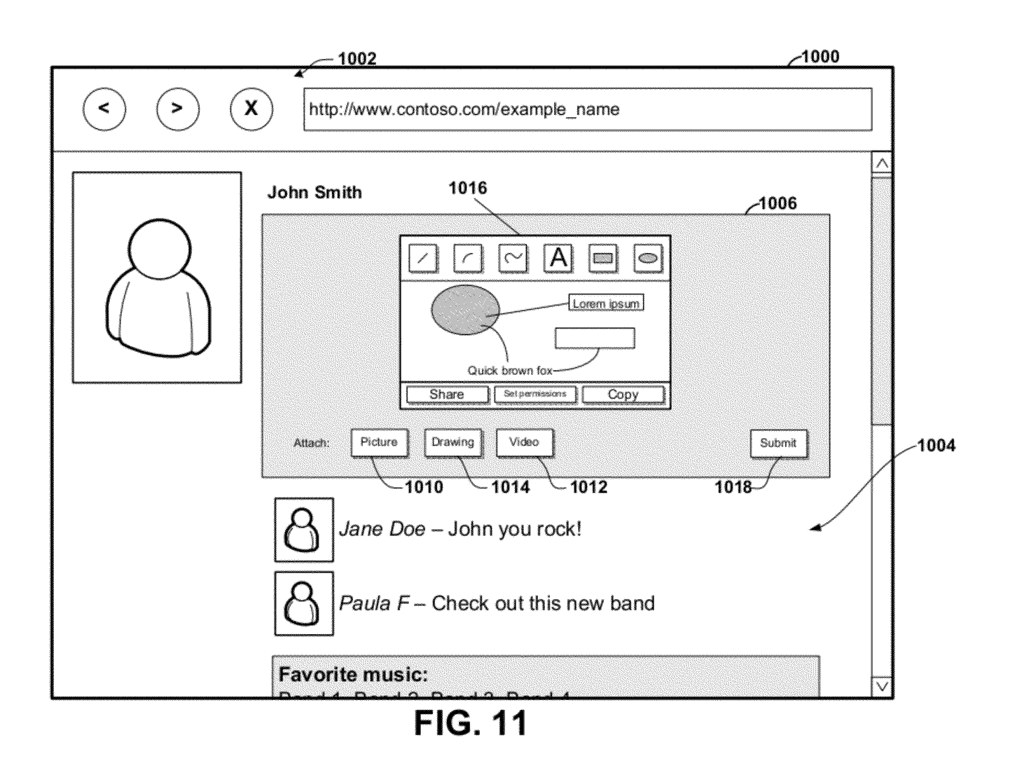

The status update area 1006 also includes a drawing control 1014. When the user selects the drawing control 1014, a canvas appears in the status update area 1006. FIG. 11 is an example screen illustration that shows the webpage 1004 when a canvas 1016 is displayed in the status update area 1006. The user can edit the drawing in the canvas 1016 while the canvas 1016 is in the status update area 1006. The user then selects a submit control 1018 to add the canvas 1016 to the webpage 1004.

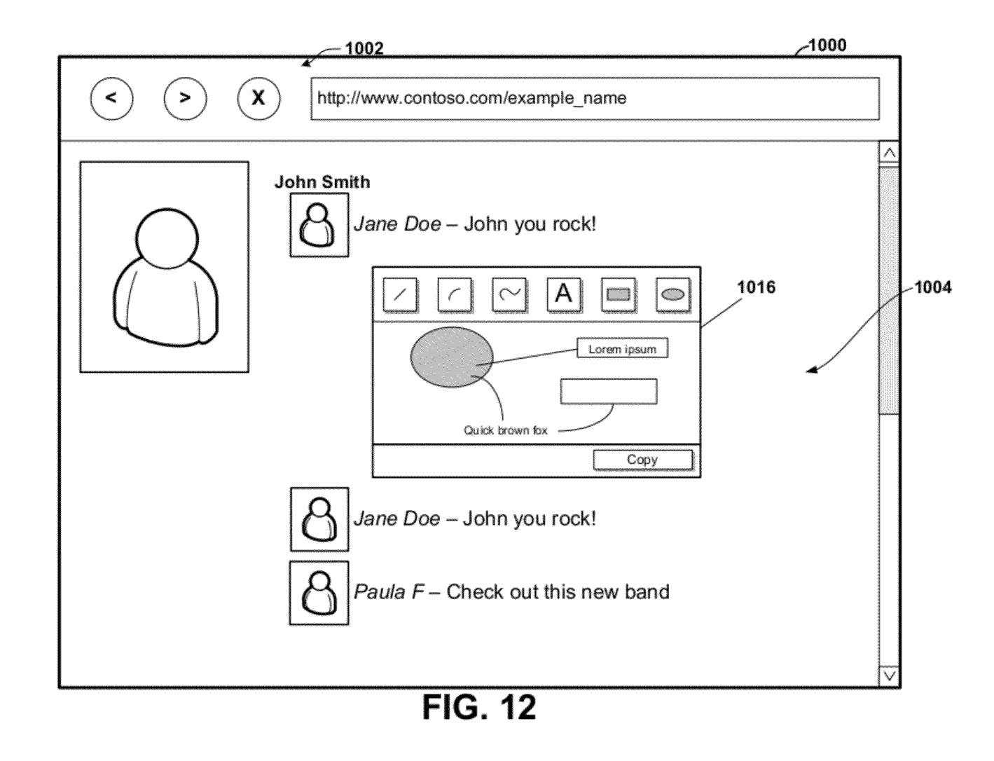

FIG. 12 is an example screen illustration that shows the webpage 1004 after the canvas 1016 has been added to webpage 914. The user “John Smith” can edit the drawing in the canvas 1016. In addition, other users who open the webpage 1004 can edit the drawing in the canvas 1016.

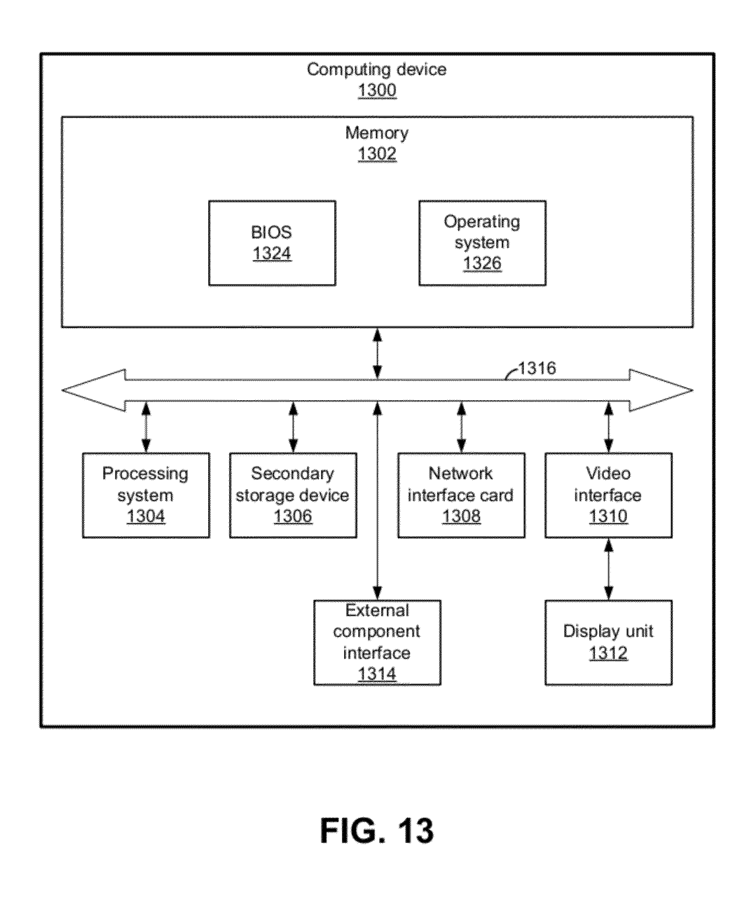

FIG. 13 is a block diagram illustrating an example computing device 1300. In some embodiments, the client devices 102 and/or the server system 106 are implemented using one or more computing devices like the computing device 1300. It should be appreciated that in other embodiments, the client devices 102 and/or the server system 106 are implemented using computing devices having hardware components other than those illustrated in the example of FIG. 13.

In different embodiments, computing devices are implemented in different ways. For instance, in the example of FIG. 13, the computing device 1300 comprises a memory 1302, a processing system 1304, a secondary storage device 1306, a network interface card 1308, a video interface 1310, a display unit 1312, an external component interface 1314, and a communication medium 1316. In other embodiments, computing devices are implemented using more or fewer hardware components. For instance, in another example embodiment, a computing device does not include a video interface, a display unit, an external storage device, or an input device.

The term computer readable media as used herein may include computer storage media. Computer storage media may include volatile and nonvolatile, removable and non-removable media implemented in any method or technology for storage of information, such as computer readable instructions, data structures, program modules, or other data. The memory 1302 includes one or more computer storage media capable of storing data and/or instructions. As used in this document, a computer storage medium is a device or article of manufacture that stores data and/or software instructions readable by a computing device. In different embodiments, the memory 1302 is implemented in different ways. For instance, in various embodiments, the memory 1302 is implemented using various types of computer storage media. Example types of computer storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The processing system 1304 includes one or more physical integrated circuits that selectively execute software instructions. In various embodiments, the processing system 1304 is implemented in various ways. For example, the processing system 1304 can be implemented as one or more processing cores. In this example, the processing system 1304 can comprise one or more Intel Core 2 microprocessors. In another example, the processing system 1304 can comprise one or more separate microprocessors. In yet another example embodiment, the processing system 1304 can comprise an ASIC that provides specific functionality. In yet another example, the processing system 1304 provides specific functionality by using an ASIC and by executing software instructions. In another example, the processing system 1304 is an ARM7 processor. In different embodiments, the processing system 1304 executes software instructions in different instruction sets. For example, the processing system 1304 executes software instructions in instruction sets such as the x86 instruction set, the POWER instruction set, a RISC instruction set, the SPARC instruction set, the IA-64 instruction set, the MIPS instruction set, and/or other instruction sets.

The secondary storage device 1306 includes one or more computer storage media. The secondary storage device 1306 stores data and software instructions not directly accessible by the processing system 1304. In other words, the processing system 1304 performs an I/O operation to retrieve data and/or software instructions from the secondary storage device 1306. In various embodiments, the secondary storage device 1306 is implemented by various types of computer-readable data storage media. For instance, the secondary storage device 1306 may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card 1308 enables the computing device 1300 to send data to and receive data from a communication network. In different embodiments, the network interface card 1308 is implemented in different ways. For example, in various embodiments, the network interface card 1308 is implemented as an Ethernet interface, a token-ring network interface, a fiber optic network interface, a wireless network interface (e.g., WiFi, WiMax, etc.), or another type of network interface.

The video interface 1310 enables the computing device 1300 to output video information to the display unit 1312. In different embodiments, the video interface 1310 is implemented in different ways. For instance, in one example embodiment, the video interface 1310 is integrated into a motherboard of the computing device 1300. In another example embodiment, the video interface 1310 is a video expansion card. In various embodiments, the display unit 1312 can be a cathode-ray tube display, an LCD display panel, a plasma screen display panel, a touch-sensitive display panel, an LED screen, a projector, or another type of display unit. In various embodiments, the video interface 1310 communicates with the display unit 1312 in various ways. For example, the video interface 1310 can communicate with the display unit 1312 via a Universal Serial Bus (USB) connector, a VGA connector, a digital visual interface (DVI) connector, an S-Video connector, a High-Definition Multimedia Interface (HDMI) interface, a DisplayPort connector, or another type of connection.

The external component interface 1314 enables the computing device 1300 to communicate with external devices. In various embodiments, the external component interface 1314 is implemented in different ways. For example, the external component interface 1314 can be a USB interface, a FireWire interface, a serial port interface, a parallel port interface, a PS/2 interface, and/or another type of interface that enables the computing device 1300 to communicate with external devices. In different embodiments, the external component interface 1314 enables the computing device 1300 to communicate with different external components. For example, the external component interface 1314 can enable the computing device 1300 to communicate with external storage devices, input devices, speakers, phone charging jacks, modems, media player docks, other computing devices, scanners, digital cameras, a fingerprint reader, and other devices that can be connected to the computing device 1300. Example types of external storage devices include, but are not limited to, magnetic tape drives, flash memory modules, magnetic disk drives, optical disc drives, flash memory units, zip disk drives, optical jukeboxes, and other types of devices comprising one or more computer storage media. Example types of input devices include, but are not limited to, keyboards, mice, trackballs, stylus input devices, key pads, microphones, joysticks, touch-sensitive display screens, and other types of devices that provide user input to the computing device 1300.

The communications medium 1316 facilitates communication among the hardware components of the computing device 1300. In different embodiments, the communications medium 1316 facilitates communication among different components of the computing device 1300. For instance, in the example of FIG. 13, the communications medium 1316 facilitates communication among the memory 1302, the processing system 1304, the secondary storage device 1306, the network interface card 1308, the video interface 1310, and the external component interface 1314. In different implementations of the computing device 1300, the communications medium 1316 is implemented in different ways. For instance, in different implementations of the computing device 1300, the communications medium 1316 may be implemented as a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computing system Interface (SCSI) interface, or another type of communications medium.

The memory 1302 stores various types of data and/or software instructions. For instance, in the example of FIG. 13, the memory 1302 stores a Basic Input/Output System (BIOS) 1324, and an operating system 1326. The BIOS 1324 includes a set of software instructions that, when executed by the processing system 1304, cause the computing device 1300 to boot up. The operating system 1326 includes a set of software instructions that, when executed by the processing system 1304, cause the computing device 1300 to provide an operating system that coordinates the activities and sharing of resources of the computing device 1300.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders.

What is claimed is:

1. A method for communicating with drawings, the method comprising:
opening, by a client device, a webpage for a first time, the webpage containing a canvas, the canvas containing a drawing that is editable within the webpage by a user of the client device and by other users who use other client devices to open webpages that include the canvas;
while the webpage is open on the client device and without reloading the webpage, dynamically updating, by the client device, the drawing to reflect edits made to the drawing by the user and by the other users at approximately times that the user and the other users make the edits to the drawing;
closing the webpage, wherein the contents of the drawing are in a first state when the client device closes the webpage; and
opening, by the client device, the webpage for a second time, wherein when the client device opens the webpage for the second time, the drawing remains editable by the user and the contents of the drawing are in a second state, wherein the second state results from edits by the other users to the first state while the webpage was closed on the client device.

2. The method of claim 1, further comprising:
in response to the user making a first change to the drawing, sending, by the client device, a client message to a server system, the client message specifying the first change to the drawing; and
receiving, by the client device, a server message from the server system, the server message specifying a second change, the second change being by one of the other users.

3. The method of claim 2,
wherein the method further comprises:
storing, by the client device, a client model, the client model comprising XML elements that represent the drawing;
updating the client model in response to the user making the first change to the drawing; and
updating the client model in response to receiving the server message;
wherein the client message specifies the first change to the drawing by specifying changes to one or more of the XML elements in the client model; and
wherein the server message specifies the second change by specifying changes to one or more of the XML elements in the client model.

4. The method of claim 1, wherein the webpage is a social networking profile page for the user.

5. The method of claim 4, wherein the social networking profile page includes a control that enables the user to add the canvas to the social networking profile page.

6. The method of claim 1,
wherein the webpage is part of a social networking website;
wherein the method further comprises: receiving, by the client device, input to select the other users from among users of the social networking website; and
wherein those users of the social networking website that are not selected are not authorized to edit the drawing.

7. The method of claim 1, further comprising:
copying the drawing from the webpage to a clipboard; and
pasting the drawing from the clipboard into a document, wherein the drawing remains editable after the drawing is pasted into the document, wherein the document is one of the following types: a word processor document, a slideshow document, a note taking document, an email message, and a diagram editing document.

8. The method of claim 1, further comprising:
receiving, by the client device, input to select an element in the drawing; and
enabling, by the client device, the user to modify or delete the element only when none of the other users have selected the element.

9. The method of claim 8,
wherein the method further comprises:
in response to receiving the input to select the element, sending a lock request to a server system;
receiving, by the client device, a lock response from the server system;
receiving, by the client device, input to unselect the element; and
in response to receiving the input to unselect the element, sending, by the client device, an unlock request to the server system;
wherein the client device enables the user to modify or delete the element when the lock response indicates that the server system has given the client device a lock on the element, the server system giving the client device a lock on the element when no other user has selected the element; and
wherein the client device does not enable the user to modify the element when the lock response indicates that the server system has not given the client device a lock on the element, wherein the client device does not enable the user to delete the element when the lock response indicates that the server system has not given the client device a lock on the element, the server system not giving the client device the lock on the element when another user has selected the element.

10. A method comprising:
storing a server model that comprises data representing a drawing;
receiving, by a server system, a first webpage request from a first client device;
sending, by the server system, a first webpage response to the first client device in response to the first webpage request, the first webpage response comprising data representing a webpage that contains a canvas, the canvas containing the drawing, wherein the drawing is editable within the webpage by a first user, the first user using the first client device;
receiving, by the server system, a second webpage request from a second client device;
sending, by the server system, a second webpage response to the second client device, the second webpage response comprising data representing the webpage, wherein the drawing is editable within the webpage by a second user, the second user using the second client device;
receiving client messages from the first client device and the second client device, the client messages specifying changes to the drawing made by the first user and the second user;
in response to the client messages:
updating the server model to reflect the changes to the drawing;
sending, by the server system, server messages to the first client device that specify the changes to the drawing;
sending, by the server system, additional server messages to the second client device that specify the changes to the drawing;
continuing to store the server model when either or both the first client device or the second client device close the webpage;
receiving, by the server system, a third webpage request from the first client device; and
sending, by the server system, a third webpage response to the first client device in response to the third webpage request, the third webpage response comprising data that represents the webpage, wherein the drawing reflects the server model.

11. The method of claim 10,
wherein the server model comprises XML elements that represent the drawing; and
wherein the server messages specify changes to the XML elements in the server model.

12. The method of claim 11, wherein the client messages specify changes to the XML elements that represent the drawing.

13. The method of claim 10, wherein the webpage is part of a social networking website, the webpage being a social networking profile page of the first user.

14. The method of claim 13,
sending, by the server system, a list of the first user's social networking contacts to the first client device, the first user's social networking contacts including the second user; and
receiving, by the server system, a permissions message indicating that the second user is authorized to edit the drawing.

15. The method of claim 13, further comprising:
receiving, by the server system, a canvas creation request from the first client device, the canvas creation request instructing the server system to add the canvas to the webpage; and
sending, by the server system, data representing the canvas to the first client device in response to the canvas creation request.

16. The method of claim 10, wherein receiving the client messages comprises receiving client messages that indicate that elements have been added to the drawing, client messages that indicate that attributes of elements in the drawing have been modified, and client messages that indicate that elements have been deleted from the drawing.

17. The method of claim 10, further comprising:
preventing the first user from modifying or deleting a given element in the drawing when the second user has selected the given element; and
preventing the second user from modifying or deleting the given element when the first user has selected the given element.

18. The method of claim 17, wherein preventing the first user from modifying or deleting the given element comprises:
receiving, by the server system, a lock request from the first client device, the lock request specifying the given element;
in response to receiving the lock request:
determining, by the server system, whether the second client device already has a lock on the given element;
locking the given element for the first client device when the second client device does not already have the lock on the given element; and
sending, by the server system, a lock response to the first client device, the lock response indicating that the first client device has the lock on the given element when the second client device does not already have the lock on the given element, the lock response indicating that the first client device does not have the lock on the given element when the second client device already has the lock on the given element.

19. The method of claim 10, further comprising:
receiving, by the server system, an invitation message that instructs the server system to send invitations to specified users of a social networking service, the invitations inviting the users to edit the drawing; and
sending, by the server system, the invitations to the specified users in response to receiving the invitation message.

20. A computing device comprising:
a processing unit; and
a set of computer storage media that stores computer-executable instructions that, when executed by the processing unit, cause the computing device to:
open a webpage for a first time, the webpage being a social networking profile page for a user of the computing device, the webpage containing a canvas, the canvas containing a drawing that is editable within the webpage by the user and by other users who use other client devices to open webpages that include the canvas;
store a client model that comprises XML elements that represent the drawing;
while the webpage is open on the client device and without reloading the webpage:
receive input to select an element in the drawing;
enable the user to modify or delete the element only when none of the other users have selected the element;
update the client model in response to the user making a first change to the drawing;
send a client message to a server system in response to the user making the first change to the drawing, the client message specifying the first change to the drawing by specifying changes to one or more of the XML elements in the client model;
receive a server message from the server system, the server message specifying a second change to the drawing by specifying changes to one or more of the XML elements in the client model, the second change being by one of the other users;
update the client model in response to receiving the server message;
close the webpage, wherein when the computing device closes the webpage, the contents of the drawing are in a first state; and
open the webpage for a second time, wherein when the computing device opens the webpage for the second time, the drawing remains editable by the user and the contents of the drawing are in a second state, wherein the second state results from edits by the other users to the first state while the webpage was closed on the computing device.
